(19) United States
(12) Patent Application Publication
(10) Pub. No.: US 2021/0043121 A1
(43) Pub. Date: Feb. 11, 2021

(54) DISPLAY APPARATUS

(71) Applicant: LG ELECTRONICS INC., Seoul (KR)

(72) Inventor: Kangwook JUNG, Seoul (KR)

(73) Assignee: LG ELECTRONICS INC., Seoul (KR)

(21) Appl. No.: 16/968,527

(22) PCT Filed: Feb. 7, 2019
(86) PCT No.: PCT/KR2019/001540

§ 371 Date: Aug. 7, 2020

(30) Foreign Application Priority Data
Feb. 7, 2018 (KR) 10-2018-0015155

(51) Int. Cl. G09G 3/00; G09G 3/20

(52) U.S. Cl. CPC G09G 3/006; G09G 3/20; G09G 2310/08; G09G 2330/08; G09G 2320/0233; G09G 2320/0242; G09G 2330/12; G09G 2310/0275

(57) ABSTRACT

The display apparatus according to one embodiment of the present invention comprises: a display panel for outputting an image; a plurality of SD-ICs for controlling operation of the display panel; one or more source PCBs comprising the plurality of SD-ICs; a main board comprising a first memory and an SoC for processing the image and transmitting the processed image to the one or more source PCBs; and one or more interfaces for connecting each of the one or more source PCBs and the main board, wherein one source PCB of the one or more source PCBs comprises a second memory for storing spot compensation data for spot compensation of the display panel.

### TECHNICAL FIELD

The present disclosure relates to a display apparatus and, more particularly, to a display apparatus capable of compensating for stains which may appear on a screen when an image is output.

### BACKGROUND ART

Display apparatuses such as TVs may be completed by assembling separately manufactured display panels, main boards and the other parts or cases, and sold to consumers.

In general, in a process of manufacturing a display panel such as a thin film transistor-liquid crystal diode (TFT-LCD), stains may be generated due to foreign materials in a photo process of coating a TFT pattern, mask failure occurring during exposure, non-uniformity according to process conditions.

Such stains may be checked through inspection using person's eyes (visual inspection) or inspection using a camera. As a result of inspection, a display panel having a level of stain which does not exceed a predetermined criterion may be released in a state of including stain compensation data.

FIGS. 1 and 2 are views illustrating a stain compensation method of a conventional display apparatus.

Referring to FIGS. 1 and 2, a general display apparatus 1 includes a plurality of boards including a main board 2, a screen-printed circuit board (S-PCB) 3, a timing controller board 4, etc. and a display panel 5. Interfaces 6 and 7 may be provided between the main board 2 and the timing controller board 4 and between the timing controller board 4 and the S-PCB 3, thereby connecting the components.

The interfaces 6 and 7 may include a serial peripheral interface (SPI).

Conventionally, stain compensation data for compensating for the stains of the display panel 5 was stored in a memory 41 (e.g., a flash memory) included in the timing controller board 4. That is, the manufacturer of the display panel may releases the display panel in a state in which the stain compensation data is stored in the memory 41, and the manufacturer of the display apparatus 1 may finally manufacture the display apparatus 1 by assembling additional parts such as the main board 2 or cases on the display panel.

According to the conventional stain compensation operation, when an image I1 provided through various image processing operations in the main board 2 is output without performing the stain compensation operation, stains may appear on the screen as in an image I1′. The timing controller of the timing controller board 4 may apply the stain compensation data to the image I1 provided from the main board 2 stored in the memory 41, thereby transmitting an image I1″ subjected to the stain compensation operation to the S-PCB 3. A source driving IC (SD-IC) 31 may output the received image I1″ through the display panel 5. Since the image I1″ is subjected to stain compensation operation, stains may not appear or may be minimized on the screen.

However, since the conventional stain compensation operation is performed in the timing controller board 3 having a processor having relatively lower performance than the processor of the main board 2, there is a limitation in the processing performance or processing speed of the stain compensation operation. At the time of error detection of the stain compensation data, an error detection method which is relatively simple and has lower reliability than cyclic redundancy check (CRC), such as checksum, should be used.

In addition, a separate timing controller board 4 may not be provided in some display apparatuses or a timing controller may be installed in the main board 2. In such a display apparatus, since the manufacturer of the display panel cannot store the stain compensation data in the timing controller board 3 as in the related art, the display apparatus cannot perform the stain compensation operation.

### INVENTION

### Technical Problem

An object of the present disclosure is to provide a display apparatus capable of performing stain compensation operation even when a separate timing controller board is not provided.

Another object of the present disclosure is to provide a display apparatus capable of improving processing speed or performance of stain compensation operation and improving accuracy of stain compensation operation.

### Technical Solution

According to the present disclosure a display apparatus comprising: a display panel configured to output an image; a plurality of source driving-integrated circuits (SD-ICs) configured to control driving of the display panel; at least one source printed circuit board (PCB) including the plurality of SD-ICs; a main board including a system on chip (SoC) configured to process the image and transmit the processed image to the at least one source PCB, and a first memory; and at least one interface configured to connect the at least one source PCB with the main board, wherein any one of the at least one source PCB comprises a second memory configured to store stain compensation data for compensating for stain of the display panel.

wherein the SoC comprises: a processor configured to process the image; and a timing controller configured to perform stain compensation operation with respect to the image using the stain compensation data and transmit the image subjected to the stain compensation operation to the source PCB through the interface.

wherein the second memory is configured to store error checking data of the stain compensation data, and wherein the processor is configured to: obtain the stain compensation data and the error checking data from the second memory, if the stain compensation data is not stored in the first memory when the display apparatus is powered on, calculate error checking data from the stain compensation data, and determine whether the obtained stain compensation data is valid, by comparing the calculated error checking data with the obtained error checking data.

wherein the processor is configured to store the obtained stain compensation data in the first memory, when the calculated error checking data and the obtained error checking data are equal.

wherein the processor is configured to provide the obtained stain compensation data to the timing controller, when the calculated error checking data and the obtained error checking data are equal.

wherein the second memory is configured to store error checking data for the stain compensation data, and wherein the processor is configured to: if the stain compensation data is included in the first memory when the display apparatus is powered on, obtain the error checking data from the second memory, obtain the stain compensation data from the first memory, calculate error checking data from the stain compensation data, and determine whether the stain compensation data stored in the first memory is valid, by comparing the calculated error checking data with the obtained error checking data.

wherein the processor is configured to provide the stain compensation data stored in the first memory to the timing controller when the calculated error checking data and the obtained error checking data are equal.

wherein the processor is configured to obtain stain compensation data from the second memory, determine whether the obtained stain compensation data is valid, and store the stain compensation data in the first memory, when the calculated error checking data and the obtained error checking data are different.

wherein the first memory comprises the stain compensation data and error checking data for the stain compensation data, and wherein the processor is configured to respectively obtain error checking data from the first memory and the second memory and compare the obtained error checking data to determine whether the stain compensation data stored in the first memory is valid, when the display apparatus is powered on.

wherein the processor provides the stain compensation data stored in the first memory to the timing controller when the error checking data respectively obtained from the first memory and the second memory are equal.

wherein the processor is configured to obtain stain compensation data from the second memory, determine whether the obtained stain compensation data is valid and store the stain compensation data in the first memory, when the error checking data respectively obtained from the first memory and the second memory are different from each other.

A method of operating a display apparatus, the method comprising: a processor included in a main board of the display apparatus obtaining stain compensation data for stain compensation of a display panel and error checking data from a second memory included in any one of at least one source printed circuit board (PCB) including a plurality of source driving-integrated circuits (SD-ICs); the processor calculating error checking data from the obtained stain compensation data; the processor comparing the obtained error checking data with the calculated error checking data; and the processor storing the stain compensation data in a first memory included in the main board based on a result of comparison.

wherein the storing includes storing the stain compensation data in the first memory when the obtained error checking data and the calculated error checking data are equal as a result of comparison.

turning on the display apparatus; the processor obtaining the error checking data from the second memory when the stain compensation data is included in the first memory; the processor calculating error checking data from the stain compensation data stored in the first memory; and the processor determining whether the stain compensation data stored in the first memory is valid by comparing the obtained error checking data with the calculated error checking data.

wherein the determining comprises the processor storing the stain compensation data to the first memory when the obtained error checking data and the calculated error checking data are equal.

The method of claim 14, wherein the determining comprises the processor providing the stain compensation data to a timing controller included in the main board when the obtained error checking data and the calculated error checking data are equal.

wherein the determining checking comprises: when the obtained error checking data and the calculated error checking data are different from each other, the processor obtaining stain compensation data from the second memory; and the processor storing the obtained stain compensation data in the first memory when the obtained stain compensation data is valid.

wherein the determining comprises: the processor respectively obtaining error checking data from the first memory and the second memory and comparing the obtained error checking data to determining whether the stain compensation data stored in the first memory is valid.

wherein the determining comprises: when the error checking data respectively obtained from the first memory and the second memory are equal, the processor providing the stain compensation data stored in the first memory to the timing controller.

wherein the determining comprises: when the error checking data respectively obtained from the first memory and the second memory are different from each other, the processor obtaining stain compensation data from the second memory, determining whether the obtained stain compensation data is valid and storing the stain compensation data in the first memory.

### Effect of the Invention

According to various embodiments of the present disclosure, since a display apparatus can perform stain compensation operation using stain compensation data stored in a source PCB, it is possible to smoothly perform stain compensation operation even when a separate timing controller board is not provided in the display apparatus or a timing controller is included in the system on chip (SoC) of a main board.

In addition, the display apparatus can store the stain compensation data of the source PCB in the memory of the main board and use the stain compensation data stored in the memory of the main board when stain compensation operation is performed in the future. Therefore, it is possible to improve processing speed as compared to continuously obtaining the stain compensation data from the source PCB through an interface.

In addition, since the display apparatus can determine whether the stain compensation data stored in the memory of the main board is valid before stain compensation operation, it is possible to improve accuracy and reliability at the time of stain compensation operation.

In addition, since the display apparatus obtain error checking data having a data size from the memory of the source PCB and determine whether the stain compensation data stored in the memory of the main board is valid, it is possible to minimize speed delay at the time of validity checking.

### DESCRIPTION OF DRAWINGS

FIG. 1 is a schematic view showing the configuration of a conventional display apparatus.

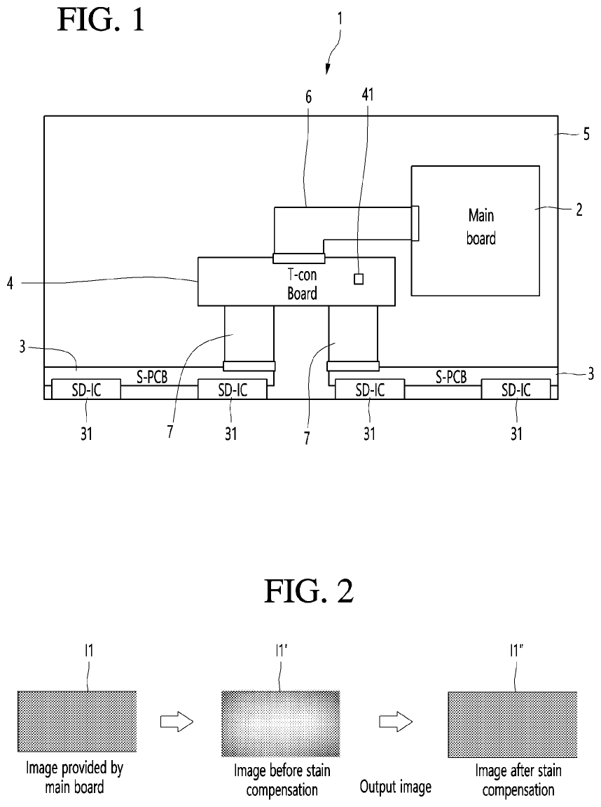

FIG. 2 is a view illustrating stain compensation operation of a conventional display apparatus.

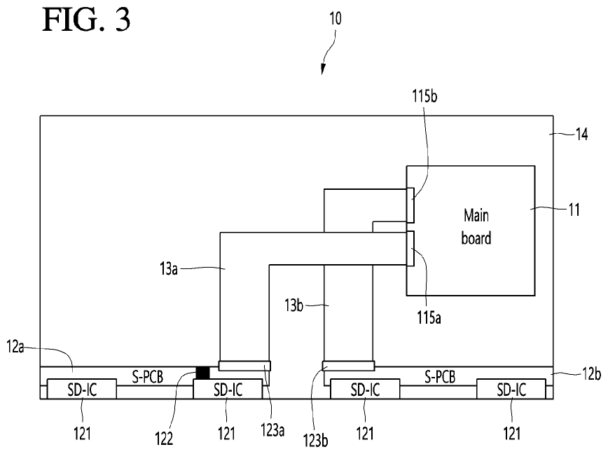

FIG. 3 is a schematic view showing the configuration of a display apparatus according to an embodiment of the present disclosure.

FIGS. 4 and 5 are views illustrating a process of obtaining stain compensation data in a main board when a display apparatus according to an embodiment of the present disclosure is first powered on.

FIGS. 6 to 8 are views illustrating stain compensation operation of a display apparatus according to an embodiment of the present disclosure.

FIG. 9 is a schematic view showing the configuration of a display apparatus according to another embodiment of the present disclosure.

### BEST MODE

Hereinafter, embodiments relating to the present disclosure will be described in detail with reference to the accompanying drawings. The suffixes “module” and “interface” for components used in the description below are assigned or mixed in consideration of easiness in writing the specification and do not have distinctive meanings or roles by themselves.

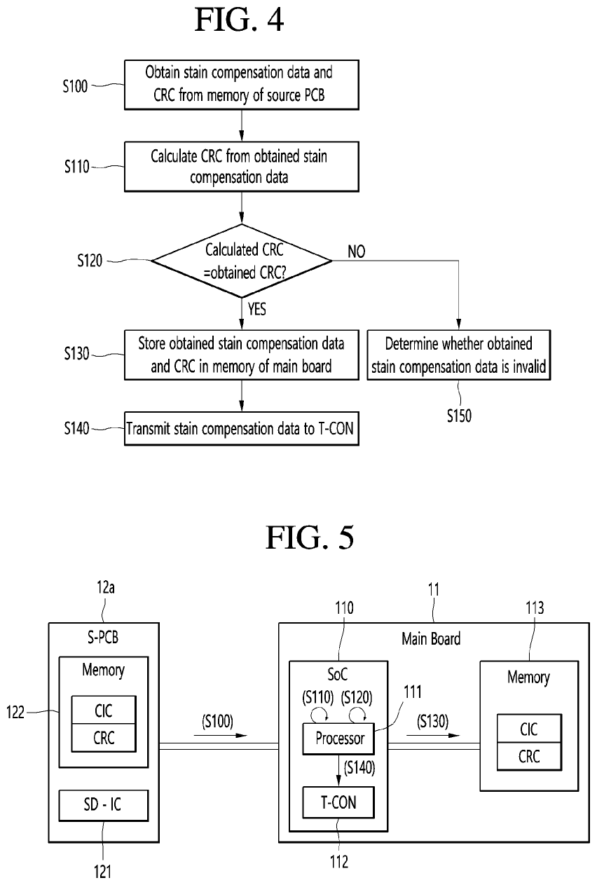

FIG. 3 is a schematic view showing the configuration of a display apparatus according to an embodiment of the present disclosure.

Referring to FIG. 3, the display apparatus 10 may include a main board 11, a plurality of S-PCBs 12a and 12b, interfaces 13a and 13b provided between the main board 11 and the plurality of S-PCBs 12a and 12b, and a display panel 14.

The main board 11 may be implemented as a module including a processor 111 (see FIG. 5) for controlling overall operation of the display apparatus 10, a timing controller 112 (see FIG. 5) for adjusting the amount of data transmitted to a source driving IC (SD-IC) and improving image quality, and a memory 113 (see FIG. 5) for storing data or algorithms necessary for operation of the processor.

For example, the processor and the timing controller may be implemented as one system on chip (SoC), but this is not limited thereto. In addition, the processor may be understood to include not only a central processing unit (CPU) but also various processors (GPU, etc.) for image processing.

Each of the plurality of S-PCBs 12a and 12b may include a plurality of source driving ICs (SD-ICs) 121. The number of S-PCBs and SD-ICs may be changed by the size of the display panel 14. For example, as the size of the display panel 14 increases, the number of S-PCBs or the number of SD-ICs may increase.

Each of the plurality of SD-ICs 121 may control driving of corresponding elements in the display panel 14 based on image information transmitted from the main board 11. By controlling driving of the elements, the image information may be output through the display panel 14.

The interfaces 13a and 13b may connect the main board 11 and the plurality of S-PCBs 12a and 12b with each other. For example, the interfaces 13a and 13b may be implemented as a serial peripheral interface (SPI)), but is not limited thereto. Interface terminals 115a, 115b, 123a and 123b for connection of the interfaces 13a and 13b may be provided in the main board 11 and the S-PCBs 12a and 12b.

In particular, according to the embodiment of the present disclosure, any one (e.g., 12a) of the plurality of S-PCBs 12a and 12b may include a memory 112 in which stain compensation data is stored. The stain compensation data may be generated and stored through inspection (in a visual manner or using a camera) after the display panel 14 is manufactured by the manufacturer of the display panel 14. For example, when the display apparatus 10 is a TV, the manufacturer of the display panel 14 may manufacture and deliver the display panel 14 and the S-PCBs 12a and 12b, and the manufacturer of the TV may assemble the main board 11, the interfaces 13a and 13b and other components on the display panel 14 and the S-PCBs 12a and 12b, thereby finally producing the TV.

That is, according to the embodiment of the present disclosure, the stain compensation data may be stored in the memory 122 of any one of the plurality of S-PCBs 12a and 12b. Therefore, stain compensation operation may be performed even in a display apparatus without a separate timing controller board.

Meanwhile, the timing controller of the main board 11 may perform stain compensation operation using the stain compensation data. The stain compensation data compensates for stain in the whole area of the display panel 14 and the size thereof may be large. At this time, if the timing controller performs stain compensation operation whenever stain compensation data is received, time delay occurs due to the data size when the stain compensation data is received through the interface 13a and, as a result, a processing speed may decrease.

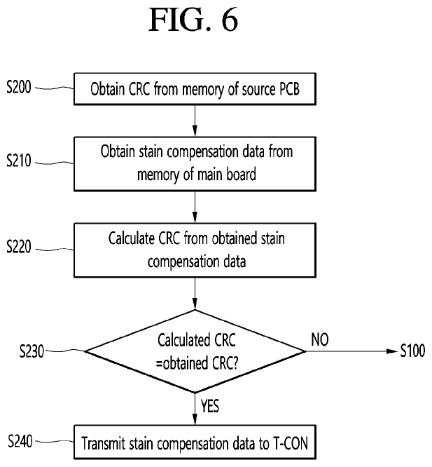

Accordingly, the display apparatus 10 according to the embodiment of the present disclosure may download the stain compensation data stored in the memory 122 of the S-PCB 12a when power is first turned on, and the timing controller may perform stain compensation operation using the stain compensation data downloaded in the memory. Embodiments related thereto will be described with reference to FIGS. 4 to 8.

FIGS. 4 and 5 are views illustrating a process of obtaining stain compensation data in a main board when a display apparatus according to an embodiment of the present disclosure is first powered on.

Referring to FIGS. 4 and 5, the display apparatus 10 may obtain, from the memory 122 of the S-PCB 12a, stain compensation data CIC and error checking data (e.g., cyclic redundancy check (CRC) (S100).

The stain compensation data CIC may include a correction value of at least one of the pixels of the display panel 14 or a plurality of regions. The correction value may mean a correction value for color or brightness.

That is, the RGB or YUV value for each pixel in the image provided from the main board 11 may be changed based on a correction value for a corresponding pixel in the stain compensation data CIC, thereby performing stain compensation operation.

In addition, the error checking data CRC for the stain compensation data CIC may be stored in the memory 112. For example, the error checking data CRC may be calculated according to a cyclic redundancy check method. The CRC may correspond to the remainder when the data stream of the stain compensation data CIC is divided by a predetermined divisor. The data stream may be a value connecting the data of the plurality of pixels, but is not limited thereto.

The processor 111 of the display apparatus 10 may receive the stain compensation data CIC and the error checking data CRC from the memory 122 of the S-PCB 12a through the interface 13a, when the display apparatus 10 is first powered on or when the stain compensation data CIC is not stored in the memory 113 of the main board 11. In some embodiments, the display apparatus 10 being first powered on may include the case where power is turned on after the main board 11 is replaced due to failure of the main board 11.

The display apparatus 10 may calculate the error checking data CRC from the obtained stain compensation data CIC (S110).

The processor 111 may calculate the error checking data CRC from the stain compensation data CIC received from the memory 122. The processor 111 may calculate the error checking data CRC based on the cyclic redundancy check method, as described above. To this end, an algorithm for calculating the error checking data CRC may be stored in the memory 113 of the main board 11.

The display apparatus 10 may compare the calculated error checking data CRC with the error checking data CRC obtained from the memory 122 (S120). The processor 111 may determine whether the obtained stain compensation data CIC is equal to the stain compensation data CIC stored in the memory 122, that is, whether the obtained stain compensation data CIC is accurate, by comparing the calculated error checking data CRC with the error checking data CRC obtained from the memory 122.

When the calculated error checking data CRC and the obtained error checking data CRC are equal as a result of comparison (YES of S120), the display apparatus 10 may store the stain compensation data CIC obtained from the memory 122 and the error checking data CRC in the memory 113 of the main board 11 (S130). The processor 111 may store the stain compensation data CIC and the error checking data CRC in the memory 113, when the calculated error checking data CRC and the obtained error checking data CRC are equal as the result of comparison. The memory 113 may be implemented as embedded multimedia card (eMMC), but is not limited thereto.

In some embodiments, the processor 111 may not store the error checking data CRC, and may store only the stain compensation data CIC in the memory 113.

The display apparatus 10 may transmit the obtained stain compensation data CIC to the timing controller 112 (S140).

The timing controller 112 may perform stain compensation operation with respect to the image received from the processor 111 based on the stain compensation data CIC. The image subjected to the stain compensation operation may be transmitted to the plurality of SD-ICs 121 included in the S-PCBs 12a and 12b, and the SD-IC 121 may drive the display panel 14 based on the received image to output the image.

In contrast, when the calculated CRC and the obtained CRC are different as the result of comparison (NO of S120), the display apparatus 10 may determine whether the obtained stain compensation data is invalid (S150). The stain compensation data being invalid may mean that some values of the stain compensation data CIC obtained by the processor 111 are changed from an original value due to transmission error or noise. When the stain compensation operation is performed using the invalid stain compensation data CIC, stain may still be present in the image displayed through the display panel 14. Therefore, when the obtained stain compensation data is invalid, the processor 111 may not store the stain compensation data, and may perform steps S100 to S120 again to obtain the stain compensation data CIC again.

That is, according to the embodiments shown in FIGS. 4 to 5, when the display apparatus 10 is first powered on, the stain compensation data CIC stored in the memory 122 of the S-PCB 12a may be downloaded and stored in the memory 113 of the main board 11. Since the timing controller 112 of the main board 11 may load the stain compensation data CIC stored in the memory 113 of the main board 11 when stain compensation operation is performed in the future, it is possible to improve a processing speed as compared to obtaining the stain compensation data CIC from the S-PCB 12a.

In addition, according to the embodiment of the present disclosure, the process of checking whether the stain compensation operation is valid may be performed by the processor 111 of the main board 11 having higher performance than the processor included in the conventional timing controller board. Therefore, in a method of generating error checking data for determining whether the stain compensation data is valid, since the CRC method having higher reliability than the conventional checksum may be used, it is possible to improve reliability of the stain compensation data.

Hereinafter, the process of performing the stain compensation operation using the stain compensation data CIC downloaded to the memory 113 of the main board 11 at the display apparatus 10 will be described in greater detail.

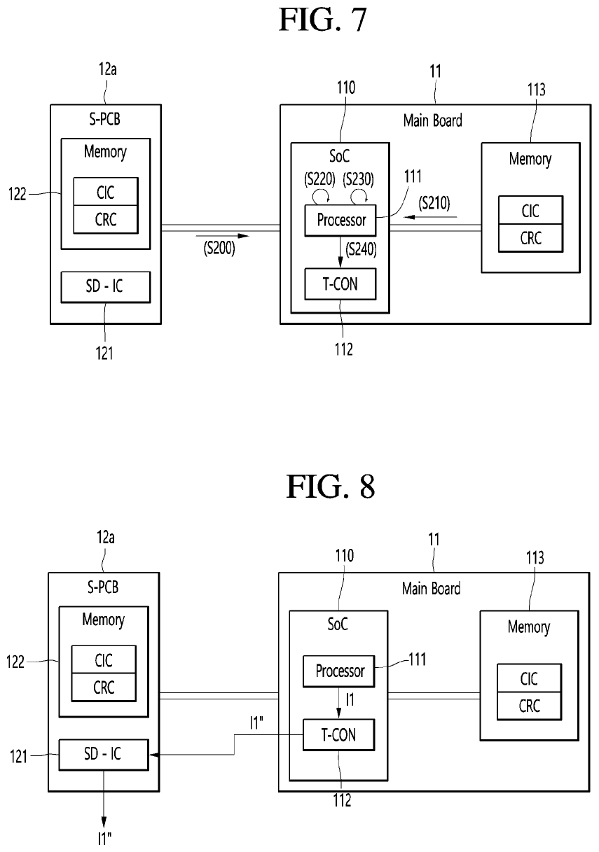

FIGS. 6 to 8 are views illustrating stain compensation operation of a display apparatus according to an embodiment of the present disclosure.

Referring to FIGS. 6 to 8, the display apparatus 10 may obtain the error checking data CRC from the memory 122 of the S-PCB 12a (S200), and obtain the stain compensation data CIC from the memory 113 of the main board 11 (S210).

When the display apparatus 10 is powered on, the processor 111 may obtain the error checking data CRC stored in the memory 122 of the S-PCB 12a through the interface 13a and obtain the stain compensation data CIC from the memory 113 of the main board 11. The order of steps S200 and S210 may be changed according to the embodiment.

The display apparatus 10 may calculate the error checking data CRC from the stain compensation data CIC obtained from the memory 113 (S220).

Operation of calculating the error checking data CRC at the processor 111 is similar to step S110 of FIG. 4 and thus a detailed description thereof will be omitted.

The display apparatus 10 may compare the error checking data CRC obtained in step S200 with the error checking data CRC calculated in step S220 (S230).

For example, when the stain compensation data CIC is updated due to the characteristic change of the display panel 14, the updated stain compensation data CIC may be stored in the memory 122 of the S-PCB 12a. Alternatively, the stain compensation data CIC stored in the memory 113 may be changed according to damage or errors. In this case, the stain compensation data CIC stored in the memory 113 of the main board 11 may be no longer valid.

In addition, as the stain compensation data CIC is updated, the error checking data CRC stored in the memory 122 may also be changed.

Accordingly, the processor 111 may determine whether the stain compensation data CIC is updated, by comparing the error checking data CRC obtained in step S200 with the error checking data CRC calculated in step S220.

When the calculated error checking data CRC and the obtained error checking data CRC are equal as a result of comparison (YES of S230), the display apparatus 10 may provide the stain compensation data CIC obtained from the memory 113 to the timing controller 112 (S240).

When the calculated error checking data CRC and the obtained error checking data CRC are equal, the processor 111 may determine that the stain compensation data CIC stored in the memory 113 is valid.

Therefore, the timing controller 112 may perform stain compensation operation using the stain compensation data CIC stored in the memory 113. The timing controller 112 may perform stain compensation operation with respect to an image I1 provided from the processor 111 using the stain compensation data CIC, and transmit an image I1″ subjected to stain compensation operation to an SD-IC 121 through the interfaces 13a and 13b. The SD-IC 121 may drive the display panel 14 based on the received image I1″, thereby outputting the image I1″.

In contrast, when the calculated error checking data CRC and the obtained error checking data CRC are different (NO of S230), the display apparatus 10 may perform steps S100 to S150 shown in FIG. 4, thereby obtaining the stain compensation data CIC from the memory 122 of the S-PCB 12a again.

The processor 111 may determine that the stain compensation data CIC stored in the memory 113 is no longer valid and obtain the stain compensation data CIC from the memory 122 of the S-PCB 12a.

In FIGS. 6 to 7, the processor 111 directly obtains the error checking data CRC from the stain compensation data CIC stored in the memory 113 and performs comparison with the error checking data CRC obtained from the memory 122. However, in some embodiments, the processor 111 may compare the error checking data CRC stored in the memory 113 with the error checking data CRC obtained from the memory 122 of the S-PCB 12a, instead of calculating the error checking data CRC. Therefore, the processor 111 may determine whether the stain compensation data CIC stored in the S-PCB 12a is updated and download the updated stain compensation data CIC to the memory 113 again.

That is, according to the embodiments of FIGS. 6 to 8, the display apparatus 10 may determine whether the stain compensation data CIC stored in the memory 113 is valid before performing stain compensation operation, thereby further improving reliability of stain compensation. In addition, the display apparatus 10 may receive only the error checking data CRC having a small data size from the memory 122 of the S-PCB 12a, thereby minimizing speed delay at the time of determining whether the data is valid.

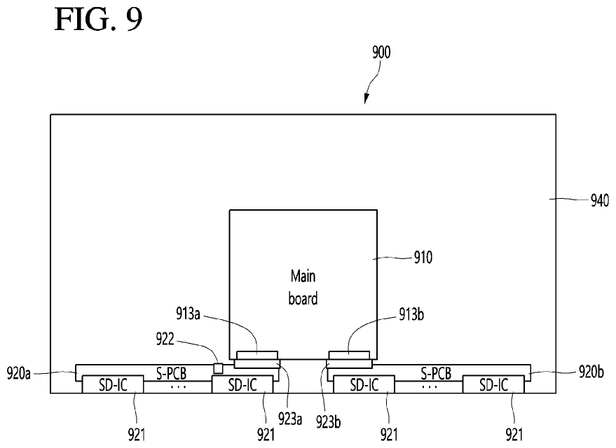

FIG. 9 is a schematic view showing the configuration of a display apparatus according to another embodiment of the present disclosure.

Referring to FIG. 9, the display apparatus 900 may be implemented in the form in which a main board 910 and S-PCBs 920a and 920b are directly connected. In this case, the terminals 913a and 913b of the main board 910 may be inserted into and coupled to the terminals 923a and 923b of the S-PCBs 920a and 920b (or vice versa).

In this case, a separate interface may not be present between the main board 910 and the S-PCBs 920a and 920b. Accordingly, since data transmission/reception delay between the main board 910 and the S-PCBs 920a and 920b may be minimized, it is possible to improve performance of the display apparatus 900.

According to an embodiment of the present disclosure, the above-described method may be embodied as a processor readable code on a medium in which a program is recorded. Examples of processor-readable media include ROM, RAM, CD-ROM, magnetic tape, floppy disk, optical data storage device, and the like.

The display apparatus described above may not be limitedly applied to the configuration and method of the above-described embodiments, but the embodiments may be configured by selectively combining all or some of the embodiments so that various modifications may be made.

1-16. (canceled)

17. A display apparatus comprising:
a display panel configured to display an image;
a plurality of source driving-integrated circuits (SD-ICs) configured to control driving of the display panel;
at least one source printed circuit board (PCB) including the plurality of SD-ICs;
a main board operably coupled with the at least one source PCB and including a system on chip (SoC) comprising a processor configured to process the image and to transmit the processed image to the at least one source PCB, and a first memory; and
wherein any one of the at least one source PCB comprises a second memory configured to store stain compensation data to compensate for stains that appear on the display panel.

18. The display apparatus of claim 17, wherein the SoC further comprises a timing controller configured to perform a stain compensation operation with respect to the image by using the stored stain compensation data and to transmit the processed image subjected to the stain compensation operation to the at least one source PCB.

19. The display apparatus of claim 18,
wherein the second memory is further configured to store error checking data corresponding to the stain compensation data, and
wherein the processor is further configured to:
obtain the stain compensation data and the stored error checking data from the second memory based on a determination that the stored stain compensation data is not stored in the first memory when the display apparatus is powered on,
determine additional error checking data from the obtained stain compensation data, and
determine whether the obtained stain compensation data is valid by comparing the determined additional error checking data with the obtained error checking data.

20. The display apparatus of claim 19, wherein the processor is further configured to store the obtained stain compensation data in the first memory based on a determination that the determined additional error checking data is equal to the obtained error checking data.

21. The display apparatus of claim 19, wherein the processor is further configured to provide the obtained stain compensation data to the timing controller based on a determination that the determined additional error checking data is equal to the obtained error checking data.

22. The display apparatus of claim 18,
wherein the second memory is configured to store error checking data corresponding to the stored stain compensation data, and
wherein the processor is further configured to:
obtain the error checking data from the second memory based on a determination that the stored stain compensation data is stored in the first memory when the display apparatus is powered on,
obtain the stored stain compensation data from the first memory,
determine additional error checking data from the obtained stain compensation data, and
determine whether the obtained stain compensation data stored in the first memory is valid by comparing the determined additional error checking data with the obtained error checking data.

23. The display apparatus of claim 22, wherein the processor is further configured to provide the obtained stain compensation data from the first memory to the timing controller based on a determination that the determined error checking data is equal to the obtained error checking data.

24. The display apparatus of claim 22, wherein the processor is further configured to:
obtain the stored stain compensation data from the second memory,
determine whether the obtained stored stain compensation data from the second memory is valid by comparing the obtained error checking data with the determined error checking data, and
store the obtained stain compensation data in the first memory based on a determination that the determined error checking data is different than the obtained error checking data.

25. The display apparatus of claim 22,
wherein the first memory comprises the obtained stain compensation data and determined error checking data for the obtained stain compensation data, and
wherein the processor is further configured to obtain first error checking data from the first memory and additional error checking data from the second memory and to compare the obtained first error checking data with the obtained second error checking data to determine whether the obtained stain compensation data stored in the first memory is valid when the display apparatus is powered on.

26. The display apparatus of claim 25, wherein the processor is further configured to provide the obtained stain compensation data to the timing controller based on a determination that the obtained first error checking data is equal to the obtained additional error checking data.

27. The display apparatus of claim 25, wherein the processor is further configured to:
obtain the stored stain compensation data from the second memory,
determine whether the obtained stain compensation data from the second memory is valid, and
store the obtained stain compensation data in the first memory based on a determination that the first error checking data obtained from the first memory is different than the additional error checking data obtained from second memory.

28. A method of operating a display apparatus, the method comprising:
obtaining stain compensation data to compensate for stains that appear on a display panel and a first error checking data from a second memory included in any one of at least one source printed circuit board (PCB) including a plurality of source driving-integrated circuits (SD-ICs);
determining additional error checking data from the obtained stain compensation data; and
storing the obtained stain compensation data in a first memory based on comparing the first obtained error checking data with the additional determined error checking data.

29. The method of claim 28, wherein the obtained stain compensation data is stored in the first memory based on a determination that the stored obtained error checking data is equal to the additional determined error checking data.

30. The method of claim 28, further comprising:
turning on the display apparatus;
obtaining the first obtained error checking data from the second memory based on a determination that the obtained stain compensation data is included in the first memory;
determining error checking data from the stored obtained stain compensation data from in the first memory; and
determining whether the stored obtained stain compensation data from the first memory is valid by comparing the first obtained error checking data with the additional determined error checking data.

31. The method of claim 30, wherein determining the error checking data checking further comprises storing the obtained stain compensation data to the first memory based on a determination that the first obtained error checking data is equal to the additional determined error checking data.

32. The method of claim 30, wherein determining the error checking data further comprises providing the obtained stain compensation data to a timing controller based on a determination that the first obtained error checking data is equal to the additional determined error checking data, where the timing controller is included in a main board.

33. The method of claim 30, wherein determining the error checking data further comprises:
obtaining the stored obtained stain compensation data from the second memory based on a determination that the first obtained error checking data is different from the additional determined error checking data; and
storing the stored obtained stain compensation data in the first memory when the stored obtained stain compensation data is determined to be valid.

34. The method of claim 30, wherein determining the error checking data further comprises obtaining a first error checking data from the first memory and additional error checking data from the second memory and comparing the obtained first error checking data with the obtained additional error checking data to determine whether the obtained stain compensation data stored in the first memory is valid.

35. The method of claim 30, wherein the determining the error checking data further comprises:
providing the stored obtained stain compensation data stored in the first memory to a timing controller based on a determination that a first error checking data obtained from the first memory is equal to an additional error checking data obtained from the second memory, where the timing controller is included in a main board.

36. The method of claim 30, wherein the determining the error checking data further comprises:
obtaining the stored obtained stain compensation data from the second memory based on a determination that a first error checking data from the first memory is different than an additional error checking data from the second memory,
determining whether the stored obtained stain compensation data is valid by comparing the obtained error checking data with the determined error checking data, and
storing the stored obtained stain compensation data in the first memory.
